(19) United States
(12) Patent Application Publication
(10) Pub. No.: US 2010/0063858 A1
(43) Pub. Date: Mar. 11, 2010

(54) METHOD FOR REDUCING FINISHED GOODS INVENTORY FOR PRECAST FABRICATOR

(76) Inventor: Chien-Ho KO, Pingtung County (TW)

Correspondence Address: Muncy, Geissler, Olds & Lowe, PLLC, P.O. BOX 1364, FAIRFAX, VA, 22038-1364, US

(21) Appl. No.: 12/357,933

(22) Filed: Jan. 22, 2009

(30) Foreign Application Priority Data
Sep. 11, 2008 (TW) 097134899
Nov. 21, 2008 (TW) 097145177

(51) Int. Cl. G06Q 10/00; G06Q 50/00

(52) U.S. Cl. 705/8; 705/10

(57) ABSTRACT

A method for reducing finished goods inventory for a precast fabricator includes a buffer evaluation procedure to evaluate a time buffer via a fuzzy logic using customer characteristics, element characteristics, and building characteristics as parameters. A due date adjustment procedure is then carried out to adjust production due dates of the elements according to the time buffer and erection dates of the building. Finally, a production scheduling procedure is used to arrange a production sequence for fabricating the elements based on the adjusted production due dates.

### BACKGROUND OF THE INVENTION

1. Field of the Invention

The present invention relates to a method for reducing finished goods inventory for a precast fabricator.

2. Description of the Related Art

Precast construction is a method where the building is built up by components or elements such as beams, columns, walls, and plates that are prefabricated in a factory and then delivered to the construction end such as a construction site and assembled. This method can largely reduce uncertainty than those cast in the construction site. To support construction schedule, the precast fabricators deliver the components or elements to the construction site according to its erection schedule to prevent late delivery that may lead to a breach of contract and, thus, result in penalty as well as lost of business reputation. Thus, the precast fabricators generally start production once they receive design information.

However, the construction site may not have enough space to store the bulky precast elements before they are assembled, such that the precast elements are often stored in the precast fabricators waiting to be delivered. Thus, the precast fabricators need a relatively large space for storing the finished goods, resulting in a significant increase in the inventory costs.

Demand variability is one of the big problems to the precast fabricators. The precast fabricators generally start production once they receive design information, but the customers may change the sizes of the elements, such that the finished precast elements can not be utilized. Furthermore, the precast elements include concrete that can not be recycled, leading to loss to the precast fabricators.

Thus, a need exists for a method for reducing finished goods inventory for a precast fabricator.

### SUMMARY OF THE INVENTION

The primary objective of the present invention is to provide a method for reducing finished goods inventory for a precast fabricator to reduce pressure of finished goods inventory and to improve the tolerance to the demand variability.

According to the present invention, a method is provided for reducing finished goods inventory for a precast fabricator that fabricates a plurality of elements for a customer constructing a building. The method includes a buffer evaluation procedure to evaluate a time buffer via fuzzy logic by considering customer characteristics, element characteristics, and building characteristics as parameters. A due date adjustment procedure is then carried out to adjust production due dates of the elements according to the time buffer and erection dates of the building. Then, a production scheduling procedure is carried out to arrange a production sequence for fabricating the elements based on the adjusted production due dates.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a flowchart of a method for reducing finished goods inventory for a precast fabricator, which is established according to the preferred teachings of the present invention.

FIG. 2 shows a diagram of ownership membership function.

FIG. 3 shows a diagram of time buffer membership.

FIG. 4 shows a flowchart of an evolutionary process of multi-objective genetic algorithms.

FIG. 5 shows a production strategy utilized to reduce inventory level.

### DETAILED DESCRIPTION OF THE INVENTION

To avoid loss resulting from the change in the sizes of the precast elements, the present invention provides a method for reducing finished goods inventory for a precast fabricator to improve the tolerance to the demand variability and to reduce the finished goods inventory.

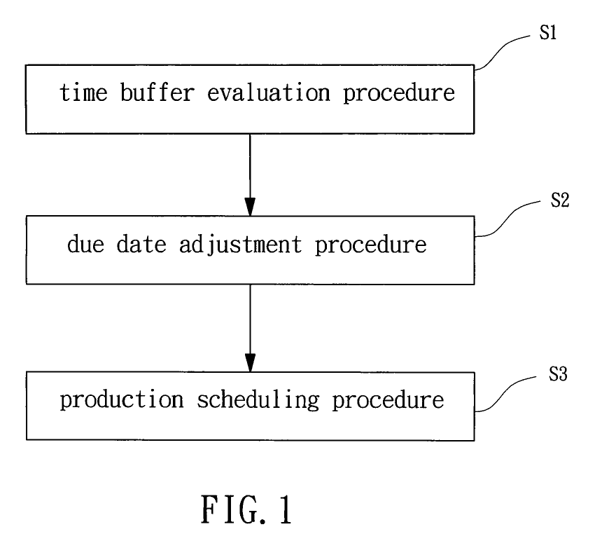

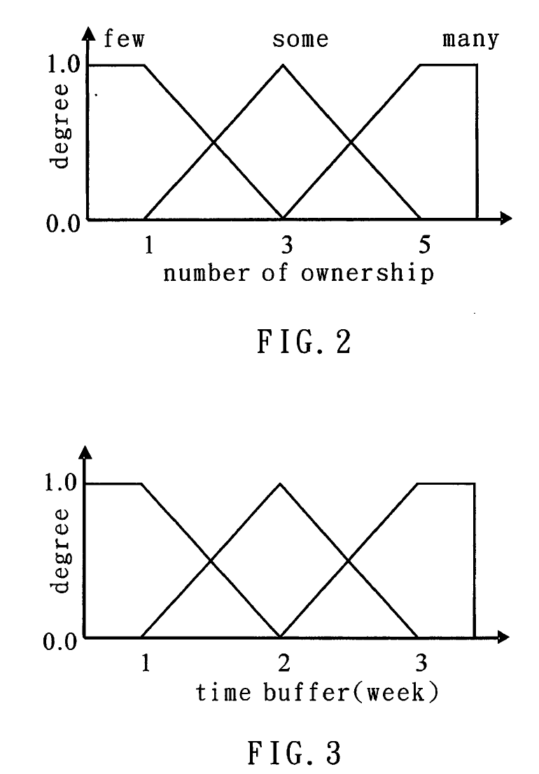

The method established according to the preferred teachings of the present invention generally includes a time buffer evaluation procedure S1 (FIG. 1). Specifically, in the time buffer evaluation procedure, a time buffer is evaluated via fuzzy logic using customer characteristics, precast element characteristics, and building characteristics as parameters. The customer characteristics include ownership of the precast elements, which is one of the main factors affecting the demand variability. More owners have more diverse opinions, and therefore increase the demand variability. The production due date of the precast elements should be postponed whenever possible to improve the tolerance to the demand variability. The precast element characteristics include the types of the precast elements such as structure, wall, column, beam, or curtain wall. These elements may have different possibilities in demand variability. For example, the possibility of size change of non-structural elements such as curtain walls is higher than that of structural elements. Thus, the production due dates of the non-structural elements can be postponed whenever possible to improve the tolerance to the demand variability. The building characteristics may be varied according to the types and function of the buildings such as apartments, shopping malls, and business buildings. The time buffer can be evaluated by utilizing the customer characteristics, the precast element characteristics, and the building characteristics that are taken into the strategic consideration for production as the parameters of the fuzzy logic.

The fuzzy logic includes a fuzzification in which the parameters are fuzzified to obtain a plurality of initial fuzzy parameters. In an embodiment, the number of ownership of the precast elements, before it is fuzzified, is classified into three degrees: few, some, and many.

Next, an operation utilizing the initial fuzzy parameters is carried out according to fuzzy rules to obtain fuzzified parameters. Table 1 shows the fuzzy rules of the embodiment, wherein the customer characteristics is the number of the ownership, and the precast element characteristics includes structure, wall, and curtain wall.

TABLE 1
Fuzzy rules

| No. | Fuzzy Rules |
|---|---|
| 1 | If Ownership is Many AND elements are Structure then time |
| | buffer is Long. |
| 2 | If Ownership is Many AND elements are Walls then time buffer is |
| | Short. |
| 3 | If Ownership is Many AND elements are Curtain Walls then time |
| | buffer is Long. |
| 4 | If Ownership is Some AND elements are Structure then time |
| | buffer is Long. |
| 5 | If Ownership is Some AND elements are Walls then time buffer is |
| | Medium. |
| 6 | If Ownership is Some AND elements are Curtain Walls then time |
| | buffer is Long. |
| 7 | If Ownership is Few AND elements are Structure then time buffer |
| | is Long. |
| 8 | If Ownership is Few AND elements are Walls then time buffer is |
| | Long. |
| 9 | If Ownership is Few AND elements are Curtain Walls then time |
| | buffer is Long. |

Then, defuzzification is carried out to obtain the time buffer by defuzzifying the fuzzified parameters. The time buffer evaluation procedure S1 is completed after the time buffer is obtained. The reliability of the time buffer is increased, as the obtained time buffer takes the customer characteristics, the precast element characteristics, and the building characteristics into consideration, as mentioned above.

The method established according to the preferred teachings of the present invention further includes a due date adjustment procedure S2 (FIG. 1) for adjusting the production due dates of the precast elements according to the time buffer and the erection dates of the building.

The method established according to the preferred teachings of the present invention further includes a production scheduling procedure S3 (FIG. 1) for arranging a production sequence based on the production due dates. In this embodiment, multi-objective genetic algorithms (MOGA) are utilized in the production scheduling procedure. Specifically, the MOGA are used to arrange a production schedule according to a precast production model.

Flowshop sequencing problem regards production as a continuous flow. In practice, a buffer size between stations is limited due to the large size of precast elements. The stations include a plurality of machines for completing fabrication of the precast elements. In this embodiment, the capacity of at least one buffer size is utilized as one of the considered parameters. The at least one buffer size is between two consecutive machines. Typical equation used to calculate completion time is shown in Equation (1).

C(Jⱼ,Mₖ)=Max{C(Jⱼ₋₁,Mₖ)+WT_{j-1,k},C(Jⱼ,Mₖ₋₁)}+Pⱼₖ (1)

where C(Jⱼ,Mₖ) denotes completion time for jth element in k machine, Pⱼₖ is an operation time for jth element in k machine (Pⱼₖ≧0). WT_{j-1,k} is the time for (j−1)th element in k machine waiting to be sent to the buffer size, which can be represented using Equation (2).

$${WT}_{j , k} = \{ \begin{matrix}C ( {J}_{j - {B}_{k}} , {M}_{k + 1} ) - {P}_{j - {B}_{k} , k + 1} - C ( {J}_{j} , {M}_{k} ) & … & if & … & C ( {J}_{j} , {M}_{k} ) < C ( {J}_{j - {B}_{k}} , {M}_{k + 1} ) - {P}_{j - {B}_{k} , k + 1} \\ 0 & … & if & … & C ( {J}_{j} , {M}_{k} ) \geq C ( {J}_{j - {B}_{k}} , {M}_{k + 1} ) - {P}_{j - {B}_{k} , k + 1}\end{matrix} \} \qquad ( 2 )$$

In Equation (2), Bₖ is the buffer size between k th machine and (k+1)th machine. When completion time of Bₖ th element at machine k is later than the beginning time of machine (k+1), buffer size Bₖ is not fully filled; otherwise, waiting time occurs.

Unlike general flowshop sequencing problems, precast production features interruptible and uninterruptible activities. The situation is formulated in Equation (3).

$$C ( {J}_{j} , {M}_{k} ) = \{ \begin{matrix}T & … & if & … & T < 24 D + {H}_{W} \\ T + {H}_{N} & … & if & … & T \geq 24 D + {H}_{W}\end{matrix} \} \qquad ( 3 )$$

where k denotes interruptible stations (k=1, 2, 5, 6), T denotes accumulated completion time calculated by Equation (4), and D is working days represented using Equation (5).

T=Max{C(Jⱼ₋₁,Mₖ),C(Jⱼ,Mₖ₋₁)}+Pⱼₖ (4)

D=integer(T/24) (5)

Concrete casting is an uninterruptible activity. The job must be postponed to the next working day if it cannot be completed within working hour or overtime. Completion time for concrete casting can be calculated using Equation (6).

$$C ( {J}_{j} , {M}_{3} ) = \{ \begin{matrix}T & … & if & … & T \leq 24 D + {H}_{W} + {H}_{E} \\ 24 ( D + 1 ) + {P}_{jk} & … & if & … & T > 24 D + {H}_{W} + {H}_{E}\end{matrix} \} \qquad ( 6 )$$

Curing is also an uninterruptible activity. Completion time of jth element in curing is formulated by Equation (7).

$$C ( {J}_{j} , {M}_{4} ) = \{ \begin{matrix}{T}^{*} & … & if & … & {T}^{*} < 24 D + {H}_{W} \\ 24 ( D + 1 ) & … & if & … & 24 D + {H}_{W} \leq {T}^{*} < 24 ( D + 1 ) \\ {T}^{*} & … & if & … & 24 ( D + 1 ) \leq {T}^{*}\end{matrix} \} \qquad ( 7 )$$

where T* is a curing time that can be calculated using the following equation:

T*=C(Jⱼ,M₃)+Pⱼ₄ (8)

A time that jth element waits for type $ mold is represented in Equation (9).

C(J_{j,$},M₀)=MinX_{$}{∀y{C(J_{y,$},M₅)}} (9)

where X_{$} denotes number of type $ mold.

Schedule evaluation criteria utilized in the production scheduling procedure will now be described.

The purpose of employing the production scheduling is to arrange the production sequence that finishes the products on the due dates. Schedule performance therefore is evaluated by its makespan and on-time penalty. The makespan C can be calculated using formula (10).

ƒ₁(σ)=Cₘₐₓ=C(Jₙ,Mₘ) (10)

where σ is C(Jₙ, Mₘ).

The other index is tardiness and earliness penalty. To achieve the goal of finishing products on due dates, tardiness and earliness are considered as costs in production schedules. Finishing products earlier increases level of finished goods inventory and risks the fabricator under the impact of demand variability. On the contrary, finishing products later risks the fabricator out of capacity. The total penalty costs are represented as Equation (11).

$${f}_{2} ( σ ) = {\sum }_{j = 1}^{n} {τ}_{j} \cdot Max ( 0 , {C}_{j} - {d}_{j} ) + {\sum }_{j = 1}^{n} {ɛ}_{j} \cdot Max ( 0 , {d}_{j} - {C}_{j} ) \qquad ( 11 )$$

where dⱼ denotes production due date for job j, τⱼ is a unit cost of tardiness for job j, and εⱼ is a unit inventory cost for job j.

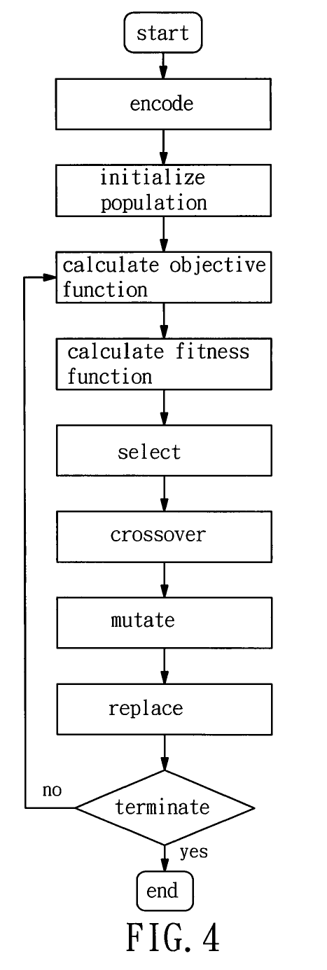

FIG. 4 shows an evolutionary process of the multi-objective genetic algorithms each step of which will now be described.

1. Encode: The parameters are encoded for operation. Factors affecting the production makespan include production resources and the production sequence. Some production resources such as number of cranes and factory size can not be changed by schedulers. Others such as buffer size between stations, mold number, and working hours can be determined. The production schedule is encoded by job sequence.

2. Initialize population: The variation of initial solution with higher fitness value can improve searching efficiency. To provide an equal chance for every state space, a set of initial solutions are randomly generated and regarded as chromosomes of the zero generation to provide the same opportunity for all state spaces. Those chromosomes offer a base for further evolutionary process.

3. Calculate objective function: In this step, the chromosomes are decoded corresponding with the precast production model. To evaluate the production schedule, multi-objectives are transferred to a single objective by a weighted sum approach. The single objective after transformation is shown in Equation (12).

ƒ(x)=ω₁(ƒ₁(x))+ω₂(θ₂(x)) (12)

where ω₁, ω₂ are positive weights (ω₁, ω₂=1), ƒ₁(x) is a makespan function shown in Equation (10), and ƒ₂(x) is a penalty function shown in Equation (11) in which dⱼ denotes production due date for job j, τⱼ is a unit cost of tardiness for job j, and εⱼ is a unit inventory cost for job j.

4. Calculate fitness function: To evaluate the fitness of each chromosome, Equation (12) is utilized in this embodiment.

5. Select: A selection operator is utilized to select the chromosomes surviving to the next generation according to its fitness. Higher fitness value has higher chance for survival. The purpose of the selection operator is to choose fitter chromosomes for evolving better generations. A roulette-wheel method is utilized for selection in this embodiment.

6. Crossover: The selected chromosomes exchange their features after crossover point. Genetic algorithm is utilized to extend the searching space by a crossover operator.

7. Mutate: A mutation operator produces spontaneous random changes in various chromosomes. It protects against premature loss of important notations. Shift mutation that randomly selects two points is utilized in this embodiment.

8. Replace: Replacement is a process that produced chromosomes (offspring) eliminate parent chromosomes. In this process, previous population is renewed by generated offspring. Therefore, next generation can continuously involve new solutions for evolvement.

9. Terminate conditions: Terminate conditions provide the criteria for stopping evolutionary process. In this embodiment, the evolutionary process is terminated by specified iterations.

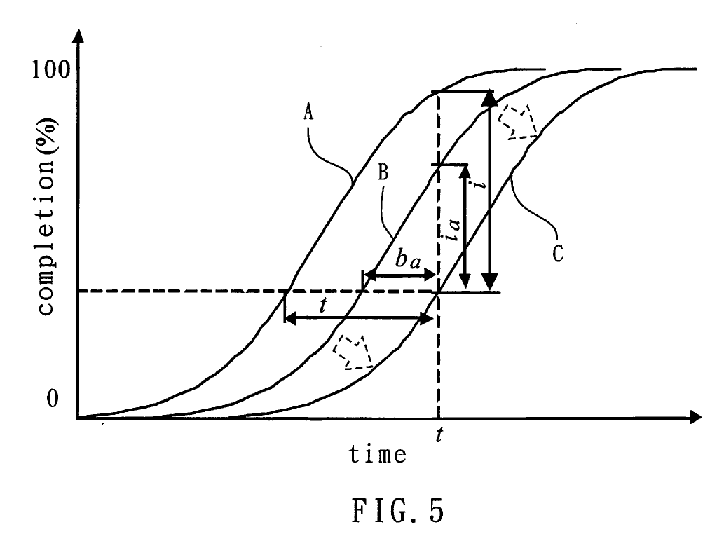

The method for reducing finished goods inventory for a precast fabricator established according to the preferred teachings of the present invention is completed after the evolutionary process is terminated. With reference to FIG. 5, curve A represents the original production curve, curve B represents the adjusted production curve, and curve C represents the erection curve. By adopting the production strategy, the adjusted production curve B is “pulled” relatively close to the erection curve C. The inventory level is decreased from to iₐ. The time of finished goods inventory waiting to be delivered is shortened from b to bₐ. Thus, both the inventory level and the impact of demand variability can be reduced.

According to the foregoing, by adopting the production strategy that takes the customer characteristics, the precast element characteristics, and the building characteristics into consideration, the time buffer can be evaluated. As a result, the production due dates can be postponed whenever possible. Finished goods inventory and the impact of demand variability can be reduced.

Since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A method for reducing finished goods inventory for a precast fabricator that fabricates a plurality of elements for a customer constructing a building, comprising:
a time buffer evaluation procedure that evaluates a time buffer using fuzzy logic by considering the characteristics of customers, elements and building as parameters;
a due date adjustment procedure that adjusts production due dates of the elements according to the evaluated time buffer and erection dates of the building; and
a production scheduling procedure that arranges a production sequence for fabricating the elements based on the adjusted production due dates.

2. The method as claimed in claim 1, with the characteristics of the customer in the time buffer evaluation procedure including a number of owners of the elements.

3. The method as claimed in claim 1, with the characteristics of the element in the time buffer evaluation procedure including types of the elements.

4. The method as claimed in claim 3, with the types of the elements including structure, wall, column, beam, and curtain wall.

5. The method as claimed in claim 1, with the characteristics of the building in the time buffer evaluation procedure including function of the building.

6. The method as claimed in claim 1, with the fuzzy logic including fuzzifying the parameters to obtain a plurality of initial fuzzy parameters; performing an operation utilizing the initial fuzzy parameters according to a plurality of fuzzy rules to obtain a plurality of fuzzified parameters; and defuzzifying the fuzzified parameters to obtain the time buffer.
